(19) United States
(12) Patent Application Publication
(10) Pub. No.: US 2002/0136001 A1
(43) Pub. Date: Sep. 26, 2002

(54) Low-profile fluorescent luminaire and methods of installation

(75) Inventors: Thomas Lefkovitz, Leawood, KS (US); William Floyd Nutt, Kansas City, KS (US); Charles Leslie Coffey, Gladstone, MO (US); Dennis Dale Oberling, Kansas City, MO (US)

Correspondence Address: Donald F. Frei, Wood, Herron & Evans, L.L.P., 2700 Carew Tower, 441 Vine Street, Cincinnati, OH, 45202-2917, US

(73) Assignee: LSI Midwest Lighting Inc.

(21) Appl. No.: 09/818,817

(22) Filed: Mar. 21, 2001

(51) Int. Cl. F21S 8/06

(52) U.S. Cl. 362/147; 362/404; 362/221; 362/290

(57) ABSTRACT

A low-profile fluorescent luminaire for attachment to a suspended ceiling and methods for retrofitting the luminaire to an existing lighting system. The low-profile fluorescent luminaire has lightweight “I”-shaped framework comprising a pair of transversely-extending end plates attached adjacent to opposed longitudinal ends of a longitudinally-extending spine. The spine and the end plates have a substantially coplanar arrangement to provide a low-profile structure that closely conforms to the ceiling. The “I”-shaped framework supports a reflector positioned below the spine and end plates when the luminaire is in a supported functional position. The low-profile luminaire can be retrofitted to a suspended ceiling to replace the existing light fixtures or to supplement the light output of an existing lighting system without modifying or removing the existing lighting fixtures.

This invention relates to lighting fixtures and, in particular, to low-profile fluorescent luminaires adapted to be mounted to a suspended ceiling. Furthermore, the invention relates to a method of installing the low-profile fluorescent luminaire to a suspended ceiling as a retrofit unit to replace obsolete existing lighting fixtures.

### BACKGROUND OF THE INVENTION

Lighting systems incorporating ceiling-mounted lighting fixtures or luminaires are routinely used to illuminate commercial floor space and objects residing on the floor space within the illuminated area. Luminaires generally consist of an assembly of components, such as lamps, ballasts, and reflectors, which cooperate to produce and direct light. Luminaires that incorporate fluorescent lamps are the most commonly used commercial light sources due to their relatively high efficiency, diffuse light distribution characteristics, and long operating life. Many conventional fluorescent lighting fixtures are adapted for recessed mounting in a suspended ceiling, in which the lighting fixtures have bulky box enclosures or troffers supported by adjacent pairs of T-bars comprising the support structure of the ceiling. In addition to housing and supporting the other components of the lighting fixture, the troffer provides a fire protection enclosure.

Over the lifetime of a commercial lighting system, the expenditures associated with operating and maintaining that system are significant. As lighting fixtures age and deteriorate, the light-emitting ability degrades and the light output per unit of consumed electrical energy is significantly reduced. Modern ballasts, lamps and reflectors are available that would significantly enhance the light-emitting ability of the lighting system and also significantly enhance the energy efficiency by reducing the power consumption. As a result, the light output could be increased while simultaneously reducing the associated energy costs. Thus, it is desirable to replace obsolete lighting fixtures with lighting fixtures that incorporate modem ballasts, lamps and lamp sockets to hold the lamps, and reflectors.

Existing lighting fixtures of commercial light systems cannot be easily upgraded to replace obsolete lighting fixtures with lighting fixtures that incorporate modern components, or refurbished with modern components to reverse the effects of deterioration. Conventional fluorescent lighting fixtures and available retrofitting kits are unsatisfactory for upgrading existing lighting systems because, among other things, the existing lighting fixtures must first be removed or, at the least, significantly modified by removing certain components from the existing lighting fixtures before the upgrade can be performed. Retrofitting with conventional fluorescent luminaires or available retrofitting kits is a labor-intensive and lengthy process that significantly disrupts commercial operations during the retrofit process. Furthermore, the removed lighting fixtures or components generate a waste stream for disposal or recycling. Disposal poses significant environmental concerns from hazardous or toxic substances in the removed components, such as mercury in the fluorescent lamps and chemicals including polychlorinated biphenyls (commonly referred to as PCB's) in the ballasts.

An objective of this invention is to provide a retrofit lighting fixture suitable for upgrading the obsolete and inadequate existing lighting systems, which is inexpensive, can be easily and rapidly installed with minimum interruption to the business, and obviates the need to remove the existing lighting fixtures of an upgraded system.

### SUMMARY OF THE INVENTION

The forgoing objective has been accomplished, according to the present invention, by providing a low-profile fluorescent luminaire which comprises a spine having a longitudinal axis extending between a spaced-apart pair of transverse edges, a pair of end plates, a longitudinally-extending reflector, a pair of lamp sockets, and a ballast. Each of the end plates is attached to the spine adjacent one of the transverse edges. Each of the end plates has a transverse dimension greater than a transverse dimension of the spine to form an “I”-shaped assembly. The spine and the end planes are positioned on one side of a horizontal plane vertically spaced from the longitudinal axis of the spine. The reflector is attached to at least one of the end plates and is positioned on the opposite side of the horizontal plane. One of the lamp sockets is mounted to each of the end plates in a confronting relationship which is longitudinally spaced for supporting the fluorescent lamp. The ballast is adapted to be operably connected between a source of electrical power and the lamp sockets for energizing the fluorescent lamp.

According to a retrofitting method of the present invention for replacing an existing lighting fixture in a suspended ceiling, a low-profile fluorescent luminaire is provided that comprises a longitudinally-extending spine, a pair of end plates mounted at opposed ends of the spine, an elongate reflector mounted longitudinally to the end plates, a ballast, and a plurality of lamp sockets arranged to hold at least one fluorescent lamp. The spine and the end plates are positioned on one side of a horizontal plane parallel the longitudinal axis and the reflector is positioned on the other side of the horizontal plane. The electrical power supply line is disconnected from a ballast of the existing lighting fixture. The low-profile fluorescent luminaire is positioned horizontally below the existing lighting fixture and adjacent to a support structure of the ceiling. The low-profile fluorescent luminaire is secured to the support structure, such as parallel T-bars, supporting the existing lighting fixture adjacent to, and beneath, the existing lighting fixture. The electrical power supply line is electrically connected to the input power line of the ballast of the low-profile fluorescent luminaire.

The low-profile fluorescent luminaire of the present invention is designed to provide a simple and rapid upgrade for an existing lighting system of a commercial building, such as a retail store or a warehouse, having a suspended panel ceiling in which the existing lighting fixtures and ceiling panels are supported by a grid support system. In a retrofit installation, the low-profile fluorescent luminaire of the present invention is quickly affixed with simple fasteners to the grid support system beneath and adjacent to one of the existing lighting fixtures. The power lines are disconnected from the ballast of the existing lighting fixture and reconnected to the ballast of the low-profile fluorescent luminaire for energizing the luminaire. Following the retrofit installation, the existing lighting fixtures remain positioned within the suspended ceiling in an intact and deenergized state. In an alternative application, the low-profile fluorescent luminaire of the present invention can be easily and rapidly installed between existing lighting fixtures as a supplemental light source for increasing the light output of a lighting system. In other applications, the low-profile fluorescent luminaire of the present invention can be affixed to a suspended ceiling as an originally-installed lighting system.

Among other beneficial attributes, the low-profile fluorescent luminaire of the present invention significantly reduces the total costs associated with an installation or a retrofitting procedure. Because the low-profile fluorescent luminaire of the present invention can be quickly installed to a suspended ceiling without removing the existing lighting fixtures, the retrofitting procedure can be conveniently scheduled to occur during non-business hours or off-peak hours of operation. As a result, the installation or retrofitting does not significantly disrupt or interrupt business operations. Furthermore, the streamlined installation procedure reduces the labor costs associated with performing the installation. Therefore, the low-profile fluorescent luminaire of the present invention significantly reduces both the direct and indirect retrofitting costs compared with either installing conventional fluorescent lighting fixtures or utilizing available retrofitting kits to upgrade an existing lighting system.

The low-profile fluorescent luminaire of the present invention significantly reduces the total costs of operating a lighting system following the installation or retrofitting procedure. The low-profile fluorescent luminaire of the present invention can incorporate efficient ballasts, efficient fluorescent lamps and compliant lamp sockets, and modem reflectors which replace the inefficient and outdated components of obsolete existing lighting fixtures. Therefore, replacing the obsolete existing lighting fixtures with low-profile fluorescent luminaires of the present invention can improve both the energy efficiency and light-emitting performance of the lighting system.

As an added benefit of the present invention, the obsolete lighting fixtures are not removed from the suspended ceiling and discarded. Because landfills are reluctant to accept items that contain hazardous or toxic substances, the disposal of certain discarded components, such as ballasts and fluorescent lamps, of the obsolete lighting fixtures can be costly. Those who retrofit must rely upon specialized disposal companies for accepting such hazardous waste streams. Moreover, those who retrofit risk significant liability if the components containing the hazardous or toxic substances are not properly disposed. In addition, disposal of the ordinary scrap metal, such as troffers, from the removed lighting fixtures would needlessly occupy valuable landfill space.

Although the obsolete lighting fixtures would present an environmental legacy, commercial buildings typically endure for many decades. Delaying the disposal of the obsolete lighting fixtures would gain the benefit of technological advances in waste disposal and recycling. Furthermore, when commercial buildings are demolished or refurbished, the obsolete lighting fixtures can be disposed of simultaneously with the demolition or refurbishment without ever disrupting commercial activities during the lifetime of the building.

These and other objectives and advantages of the present invention will be more readily apparent from the following drawings and detailed description.

### BRIEF DESCRIPTION OF THE DRAWINGS

FIG. 1 is an inverted perspective view of a fluorescent luminaire according to the present invention;

FIG. 1A is a partial perspective view of one end of the luminaire of FIG. 1;

FIG. 2 is a end view of the luminaire of FIG. 1;

FIG. 3 is a top perspective view illustrating the attachment of the fluorescent luminaire of the present invention to the T-bars of a suspended ceiling;

FIG. 4 is a top perspective view illustrating clips used to attach the fluorescent luminaire of the present invention to the T-bars of a suspended ceiling;

FIG. 5 is a partial top perspective view illustrating an alternative embodiment of a fluorescent luminaire according to the present invention; and

FIG. 6 is a schematic side view of a plurality of fluorescent luminaires arranged and interconnected electrically according to the present invention.

### DETAILED DESCRIPTION

The environment of the present invention is a ceiling of a building and, in particular, a suspended ceiling having a support structure comprising an intersecting grid support system of T-bars that supports a combination of planar ceiling panels and lighting fixtures. In its broader aspects, the present invention may be installed as an original installation, as a retrofitted replacement for an existing lighting fixture, or as a source of lighting for supplementing the light output of an existing lighting system.

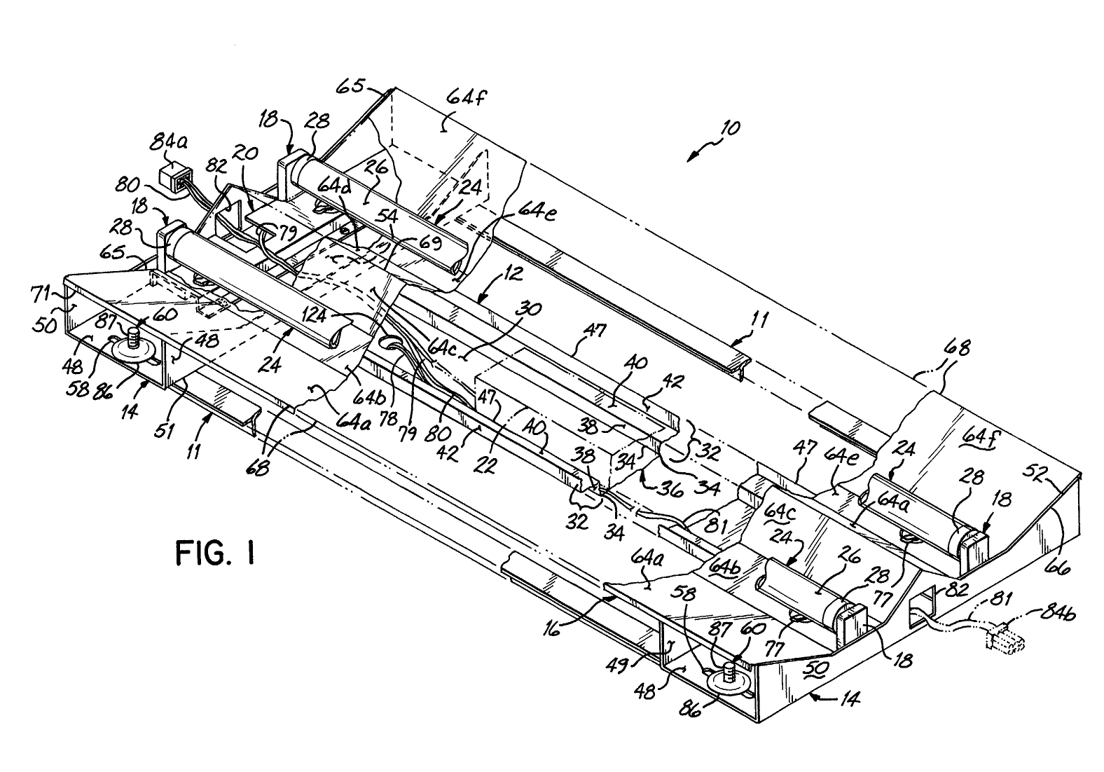

With reference to the inverted view of FIGS. 1 and 1A, a fluorescent luminaire 10 according to the present invention includes a spine 12 extending longitudinally between an opposed pair of transversely-oriented end plates 14, a reflector 16, two pairs of lamp sockets 18 and a ballast 22 attached to the spine 12. The end plates 14 and the spine 12 collectively comprise a low-profile and lightweight “I”-shaped framework that is attachable to the grid support structure of a suspended ceiling. The framework mechanically supports the reflector 16, lamp sockets 18, ballast 22, and fluorescent lamps 24. The rigidity of the “I”-shaped framework of the fluorescent luminaire 10 eliminates the necessity for a box enclosure or a troffer commonly found in conventional lighting fixtures.

Each end plate 14 includes a socket plate 20 for securing a plurality of, for example, two conventional fluorescent lamps 24 extend between respective confronting pairs of lamp sockets 18. As best shown in FIG. 1A, each lamp socket 18 is a conventional “L”-shaped structure having a base portion 18a joined at a right angle to a hanger portion 18b. Each fluorescent lamp 24 comprises an elongate tubular glass envelope 26 confining a suitable rarified gas mixture and an electrode 28 opposite ends of the envelope having, for example, one or more pins that are adapted to electrically couple with the electrically-active receptacles 19 carried by the hanger portion 18b of each lamp socket 18. The electrodes 28 are energized by electrical energy provided by the ballast 22. The electrical energy excites an electrical discharge in the rarified gas mixture, which creates ultraviolet radiation for exciting phosphors present on the interior surfaces of the glass envelope. The excited phosphors emit radiation in the visible spectrum of light for illuminating nearby line-of-sight spaces.

Although the fluorescent luminaire 10 is illustrated in FIGS. 1 and 1A as accepting two fluorescent lamps 24, this illustration is not intended to be limiting of the present invention. Accordingly, the luminaire 10 is suitable for use with alternative lamp configurations ranging from a single fluorescent lamp 24 to three or more lamps 24.

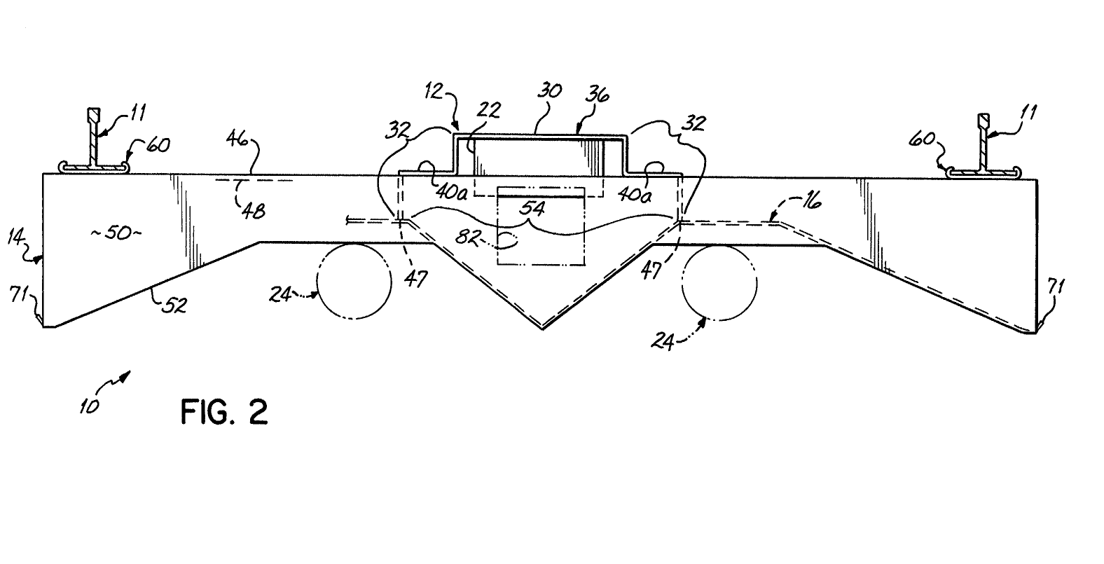

With reference to FIGS. 1, 1A, 2 and 3, the spine 12 of fluorescent luminaire 10 has a substantially planar base wall 30 and a pair of integrally-formed stepped flanges 32. One of the stepped flanges 32 projects laterally outward from each opposed side edge 34 of the base wall 30. The base wall 30 and the spaced-apart parallel pair of stepped flanges 32 collectively define a recessed channel 36 which extends substantially the longitudinal dimension of the spine 12. The recessed channel 36 provides a wireway for routing electrical power lines and the like along the length of the spine 12 and to and from the ballast 22. When the luminaire 10 is attached to the T-bars 11 of a suspended ceiling as shown in FIG. 3, the recessed channel 36 is inverted and faces downwardly toward the underlying ground or floor. Likewise, when the luminaire 10 is attached in a supported functional position to a suspended ceiling, the stepped flanges 32 project substantially downward toward the ground.

As best shown in FIG. 1A, each stepped flange 32 has a substantially-vertical inner portion 38, a substantially-horizontal bridge portion 40 and a substantially-vertical outer portion 42. The outer portion 42 is transversely spaced from the inner portion 38 and is coupled to the inner portion 38 by the substantially-horizontal bridge 40. As best shown in FIG. 1A, the outer vertical portion 42 of the stepped flange 32 is omitted adjacent opposite first and second longitudinal ends 43, 44 of the spine 12 over a longitudinal dimension, L, sufficient to permit the end plates 14 to be attached to the bridge portion 40. To that end, the longitudinal dimension of the omitted portion of the outer portions 42 is approximately equal to the longitudinal dimension of each end plate 14. A backside surface 46 of a base panel 48 of end plate 14 has a substantially direct and continuous contact with a substantially-horizontal surface 40a provided on each of the bridge portions 40 of the spine 12. As a result, a length of the recessed channel 36 extends beneath each end plate 14. A horizontal plane containing the base walls 48 is generally parallel with respect to a horizontal plane containing the surfaces 40a. A longitudinal edge 47 of each outer portion 42 is substantially linear and engages the backside of the reflector 16 in a close-fitting engagement therebetween.

With reference to FIGS. 1, 1A, 2 and 3, each of the end plates 14 includes the transversely-extending base panel 48 (as mentioned above), an integral inner vertical wall 49, and an integral outer vertical wall 50. The inner and outer vertical walls 49, 50 extend transversely along, and outwardly from, a pair of longitudinally spaced-apart transverse edges 51 of the base panel 48. Base panel 48 is substantially-planar and oriented such that the inner and outer vertical walls 49, 50 extend normal to the general direction of the stepped flanges 32 carried by the spine 12. As best shown in FIG. 1A, the outer vertical wall 50 has a transverse edge 52 that is contoured or shaped to have a profile, which substantially matches the cross-sectional profile of the reflector 16, viewed parallel to the longitudinal axis of the luminaire 10. The inner vertical wall 49 has a transverse edge 53 with a profile that closely conforms to peripheral portions of the cross-sectional profile of the reflector 16 but which retains a generally triangular-shaped gap 54 near the centerline of the inner wall 49. The end plates 14 are fastened to the spine 12 by a plurality of fasteners, such as sheet metal screws, such that the backside surface 46 of the base panel 48 contacts the surfaces 40a of the bridge portion 40 to assure rigidity of the assembly of the spine 12 and end plates 14.

The base panel 48 is generally rectangular and has a transverse dimension that is greater than a longitudinal dimension. The transverse dimension of the base panel 48, and, therefore, of each end plate 14, is greater than and, preferably, significantly greater than, a transverse dimension of the spine 12. The transverse dimension of the spine 12 is defined as the transverse separation between the outer vertical side walls 42 of the stepped flange 32.

As best shown in FIG. 1A, the base panel 48 of each end plate 14 has a pair of longitudinally-extending, transversely-spaced oval slots 58. Each slot 58 has an interior width sufficient to insertably receive a portion of one of a plurality of fasteners, such as clips 60. A plurality of clips 60 are used to attach the luminaire 10 to the T-bars 11 of a suspended ceiling, as explained below. The elongate shape of each slot 58 permits the longitudinal position of the luminaire 10 to be adjusted within the extent of the slots 58. As a result, the oval slots 58 can accommodate slight irregularities in positioning the plurality of clips 60, as compared with conventional fastening methods utilizing circular openings.

With reference to FIGS. 1, 1A and 3, the reflector 16 comprises a longitudinally-extending light-reflecting panel positioned above and shrouding the fluorescent lamps 24. A significant portion of the emitted radiation from the front side of the fluorescent lamps 24 travels with direct optical paths toward line-of-sight spaces beneath the luminaire 10. The reflector 16 is operable to reflect light emanating from the backside of the fluorescent lamps 24 along reflected optical paths toward the line-of-sight spaces. To that end, the reflector 16 has a reflective inner surface 64 which includes a plurality of transversely-flat reflecting surfaces 64a-f that extend longitudinally between spaced-apart first and second longitudinal ends 65, 66. The reflecting surfaces 64a-f are arranged such that surfaces 64b,e are substantially parallel to a plane containing the base panels 48 and surfaces 64a,c,d,f are angularly inclined with respect to surfaces 64b,e. Each of the outermost reflecting surfaces 64a,f diverge outwardly to opposed side edges 68 of the reflector 16 and the innermost reflecting surfaces 64c,d converge inwardly to join at an apex 69 near the longitudinal centerline of the reflector 16. The angular arrangement of the reflecting surfaces 64a-f provides a low-profile, segmented surface contour that redirects a portion of the visible light emitted from each fluorescent lamp 24 in order to achieve a desired distribution of light intensity below the luminaire 10 when luminaire 10 is in a supported function position. It is understood that the reflecting surfaces 64a-f may be arranged as a curved reflector having a low-profile transversely-arcuate shape without departing from the spirit and scope of the present invention.

A pair of rectangular notches 70 are provided in the reflecting surfaces 64b,e at each of the first and second longitudinal ends 65, 66 of the reflector 16. Each notch 70 is dimensioned to accommodate the hanger portion 18b of each lamp socket 18. The notches 70 are spaced apart transversely to accommodate installation of fluorescent lamps 24 in the receptacles 19 of the adjacent pairs of lamp sockets 18. Each fluorescent lamp 24 is positioned with its longitudinal axis substantially aligned with the surfaces 64b,e and is spaced vertically from the surfaces 64b,e such that a substantial portion of the light emanating from the backside of the fluorescent lamps 24 is reflected in a downward direction toward the floor or ground when the luminaire 10 is mounted to the support structure of a suspended ceiling.

As best shown in FIGS. 1 and 1A, the first and second longitudinal ends 65, 66 of the reflector 16 abut against each of the opposed outer walls 50 just slightly below the respective transverse edges 52. A lip 71 is provided on each of the opposed longitudinal edges 68 of the reflector 16. The cross-sectional profile of the reflector 16 and the contour of edges 52 are similar and provide a smooth, closely conforming abutment so that any gaps or protruding edges are minimized. It will be appreciated that the first and second longitudinal ends 65, 66 of the reflector 16 could slightly overlap or overhang the transverse edges 52 without departing from the spirit and scope of the present invention.

With reference to FIGS. 1 and 1A, each of the socket plates 20 comprises a generally-rectangular, substantially-planar platform 72, a first integral portion bent generally perpendicular to platform 72 to provide a side skirt 73, and a second integral portion bent outwardly at about 90 degrees relative to the side skirt 73 to provide a substantially planar flange 74 that is substantially parallel to the platform 72. The flange 74 of the socket plate 20 is affixed with a plurality of conventional fasteners to the base panel 48 of the end plate 14. The vertical height of the skirt 73 is equal to or slightly exceeds the vertical height of the base portion 18a of the lamp socket 18 for capturing the base portion 18a between the base panel 48 and the platform 72. The platform 72 of each socket plate 20 includes a pair of spaced-apart rectangular cut-outs or notches 75 formed adjacent an outer transverse edge 76. Notches 75 are registered with the notches 70 in the reflector 16. The lamp sockets 18 protrude vertically through the registered notches 70, 75 such that the hanger portion 18b of each lamp socket 18 projects a suitable distance above the reflecting surfaces 64b,e of the reflector 16 to permit proper spacing between the fluorescent lamps 24 and the reflective inner surface 64. Reflector 16 is fastened to each of the platforms 72 by a pair of conventional fasteners 77.

The luminaire 10 of the present invention has substantially lower overall height or profile than conventional lighting fixtures due to the substantially co-planar arrangement of the spine 12 and end plates 14. When the luminaire 10 is attached in a supported functional position to a suspended ceiling, the reflector 16 is positioned below a horizontal plane parallel to the longitudinal axis of the spine, such as a horizontal plane containing platforms 72. Conversely, the spine 12 and end plates 14 are positioned above the horizontal plane. The reflecting surfaces 64a-f of reflector 16 likewise have a low-profile arrangement for minimizing the overall profile of the luminaire 10. In an exemplary embodiment, the luminaire 10 has a vertical dimension between the base wall 30 of the spine 12 and the most distant portion of the transverse edge 52 of the outer vertical wall 50 of about 6.5 inches. Because of its lower overall profile, the luminaire 10 of the present invention closely conforms to the suspended ceiling when in a supported functional position.

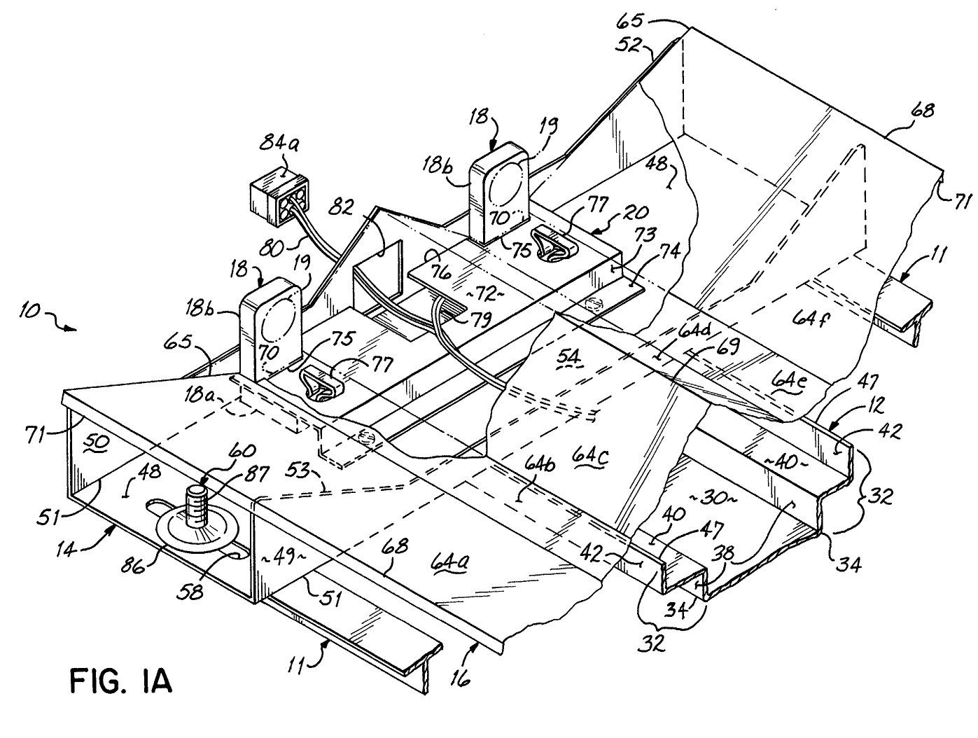

With reference to FIGS. 1 and 2, the ballast 22 is mounted within the recessed channel 36 and fastened to the base wall 30. The ballast 22 is substantially enclosed between the reflector 16 and the recessed channel 36 of the spine 12. Ballast 22 is a preferably high-efficiency ballast as understood by persons of ordinary skill in the art of fluorescent lighting. The ballast 22 converts a line voltage, such as a 120 Volt or 277 Volt AC line voltage, to a form useful for creating a discharge in the fluorescent lamps 24. Among other functions, the ballast 22 provides the necessary starting voltage to strike an arc, matches the line voltage to the operating voltage of the fluorescent lamps 24, and regulates the lamp current during operation to correlate with the changing lamp impedance.

The ballast 22 receives line voltage or electrical power from an input power line 78 that extends through a wiring cutout 124 (FIG. 3) in the base wall 30 of the spine 12 for making an electrical connection with a source of electrical power (not shown). The ballast 22 outputs suitably converted electrical power via an output power line 79. The output power line 79 extends to make a suitable electrical connection with the electrically-active receptacles 19 in the hanger portion 18b of each lamp socket 18. The input power line 78 is electrically interconnected with a pair of auxiliary power lines 80 and 81. The power lines 79, 80, 81 extend along the recessed channel 36 of spine 12 and through the generally triangular-shaped gaps 54 near the centerline of each inner wall 49 of the end plates. Auxiliary power lines 80, 81 branch from the input power line 78 such that an electrically powered device, such as a second of the luminaires 10 proximate one of the longitudinal ends of a first of the luminaires 10, may be interconnected in a parallel circuit for sharing electrical power. Auxiliary power lines 80, 81 extend through an opening 82 provided in each vertical wall 50 of the opposed end plates 14 and terminate with respective electrical connectors 84a, 84b. The electrical connectors 84a, 84b facilitate rapid electrical interconnection with, for example, one or more adjacent luminaires 10. To that end, auxiliary power lines 80, 81 are operable for optionally sharing electrical power between a plurality of adjacent luminaires 10, wherein only one of the luminaires 10 has an input power line 78 directly connected to the source of electrical power.

In a common application, the spine 12 and end plates 14 of luminaire 10 are dimensioned for accepting four-foot fluorescent lamps 24 between the lamp sockets 18 and dimensioned to match the separation distance between adjacent pairs of parallel T-bars 11, which is commonly about two feet. To limit the weight of the luminaire 10, the spine 12, end plates 14, and socket plates 20 are fabricated using conventional forming methods to bend and fold thin-walled stamped sheets of steel or aluminum into the desired shape or may be extruded or formed from aluminum. The reflector 16 is usually formed of a highly-reflective material, such as an anodized aluminum sheet or an aluminum sheet covered by a high reflectance white paint.

The fluorescent luminaire 10 is illustrated as a downlight ceiling luminaire in which reflector 16 is open and most of the light emanating from lamps 24 is directed downward. As such, the fluorescent luminaire 10 does not require a light-modifying structure, such as a lens, a diffuser, a baffle or a louver.

With reference to FIG. 3, suspended ceilings rely on a grid support structure comprising a framework of T-bars 11. The T-bars are suspended by a plurality of tie wires 11 a extending vertically to attachment points on overlying load-bearing members (not shown). Parallel rows and columns of T-bars 11 in the grid support system are separated by predetermined distances and provide a plurality of rectangular spaces which are filled by acoustical tiles or ceiling panels, HVAC vents, and lighting fixtures, such as fluorescent luminaire 10.

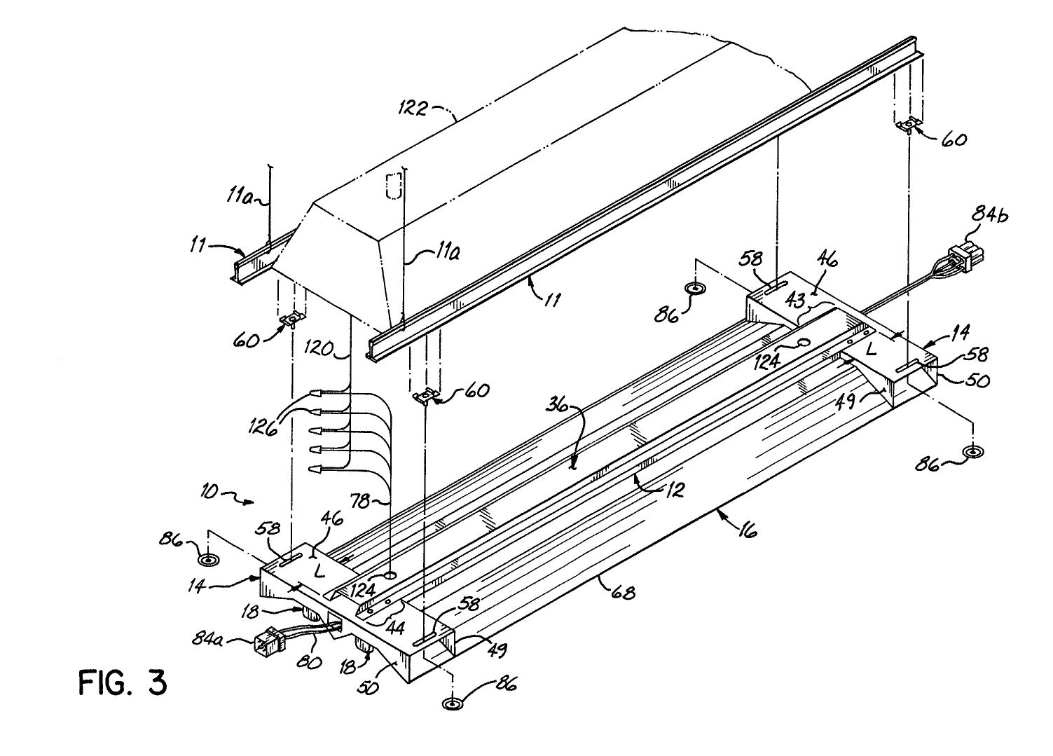

With reference to FIGS. 3 and 4, the luminaire 10 is attachable using clips 60 and nuts 86 (FIG. 1) in a supported functional position to a parallel pair of T-bars 11 in a suspended ceiling. Each of the clips 60 comprises a threaded post 87 attached to, and projecting outwardly from, a position near the geometrical center of a generally circular center flange 88. The center flange 88 has a pair of flat resilient prongs 90 that lie in the same plane as, and project in opposed directions from opposite sides of, the center flange 88. Each prong 90 has a curved tip 91 that projects above, or is vertically offset from, the plane of the center flange 88. Attached at the base of each prong 90 is a triangular folded portion 92 that overhangs the base of the prong 90 and creates a cavity 93 of a given width and depth. The opening to the cavity 93 generally faces toward the curved tip 91 of the prong 90. The clip 60 is attached to a T-bar 11 by placing the center flange 88 proximate the center of the T-bar 11 with the two prongs 90 on opposed sides of the horizontal T-bar portion and rotating the clip 60 in the direction indicated generally by arrows 94 to force the prongs 90 to slide below the horizontal portion of the T-bar 11. In its fully-engaged position, opposite sides of the horizontal portion of the T-bar 11 are received within the cavities 93 and the curved tip 91, opposite each respective cavity 93, extends beyond the edge of the T-bar 11 and springs slightly upwardly toward the plane of the folded portion 92. In the fully-engaged position, the clip 60 cannot easily rotate in a direction opposite to arrows 94 and become disengaged because the curved tip 91 would contact the horizontal portion of the T-bar 11. After positioning the luminaire 10 adjacent to the T-bars 11 of the suspended ceiling, the threaded posts 87 are inserted into the oval slots 58 in the end plates 14 and the nuts 86 are engaged to capture the thin gauge material of the end plates 14 therebetween.

The installation of the fluorescent luminaire 10 of the present invention to the support structure of a suspended ceiling is illustrated in FIG. 4. To install the luminaire 10, a number of clips 60 are attached to a transversely-spaced parallel pair of T-bars 11. The clips 60 have a longitudinal spacing approximately equal to the longitudinal spacing of slots 58. The luminaire 10 is positioned with a horizontal orientation adjacent to and below the pair of T-bars 11. The input power line 78 of ballast 22 extends through the wiring cutout 124 and is electrically connected to power line 120 running from a source of electrical power (not shown). Conventional twist-on connectors or wire nuts 126 or other conventional connectors facilitate the electrical connection between the power line 120 and the input power line 78. The threaded posts 87 of clips 60 are inserted into the slots 58 and nuts 86 are threaded onto posts 87 to attach the luminaire 10 to the T-bars 11 of the suspended ceiling. Accordingly, the transverse dimension of the end plates 14 and the transverse distance between the slots 58 of the end plates 14 is dimensioned to match the predetermined separation distance between parallel T-bars 11. After the luminaire 10 is installed in a supported functional position, fluorescent lamps 24 are installed into the lamp sockets 18.

The fluorescent luminaire 10 may be retrofitted over an existing lighting fixture 122, shown in phantom in FIG. 4. To retrofit the luminaire 10 over the existing lighting fixture 122, the power line 120 serving the existing lighting fixture 122 is disconnected from the existing ballast (not shown). The disconnected power line 120 is reconnected to the input power line 78 of ballast 22. In a supported functional position, the fluorescent luminaire 10 does not attach to, nor is it suspended from, any portion of the existing lighting fixture 122. Thus, the attachment of luminaire 10 to the T-bars 11 of the suspended ceiling is substantially independent of any attribute of the existing fixture 122. The existing lighting fixture 122 does not have to be modified prior to or during the installation of the luminaire 10 and can be left intact. For example, the existing lighting fixture 122 does not have to be delamped and the existing ballast and reflector of fixture 122 can be left in place within the suspended ceiling. Furthermore, any light-modifying structure, such as lenses, diffusers, baffles, louvers and the like, of the existing lighting fixture 122 can remain attached thereto.

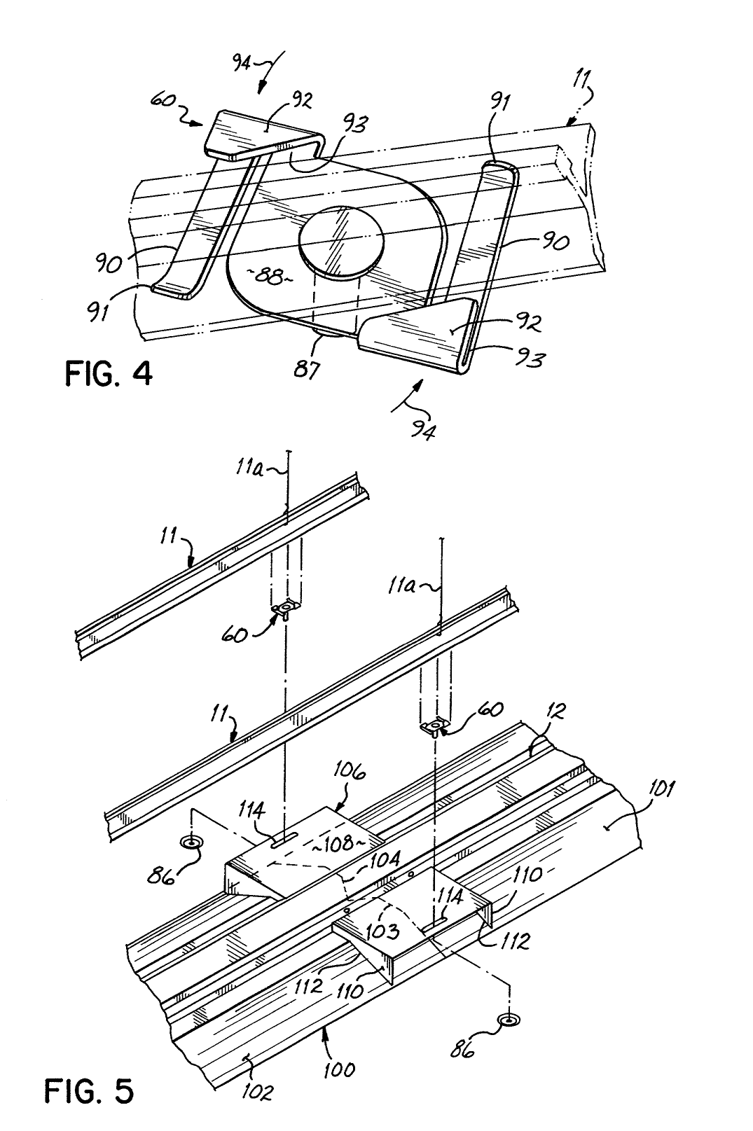

With reference to FIG. 5, an alternative embodiment of the luminaire 10 may be dimensioned to accept fluorescent lamps 24 having a length of about eight feet. To that end, spine 12 of luminaire 10 will have an extended longitudinal dimension and luminaire 10 will further include a reflector 100 which is partitioned transversely into two longitudinal sections 101, 102. Ends 103, 104 of the two longitudinal sections 101, 102, respectively, are fastened to a center plate 106 with conventional fasteners 77. The opposite longitudinal ends (not shown) are fastened with conventional fasteners 77 to the platform 72 of each socket plate 20. The center plate 106, similar in construction to end plate 14, has a base wall 108 and a pair of opposed transverse side walls 110 that project outwardly from the base wall 108. The center plate 106 is transversely attached to the backside of the base wall 30 near the midpoint of the longitudinal dimension or length of the spine 12. Similar to the inner vertical wall 49 of the end plate 14 (FIG. 1A), transverse edge 112 of each side wall 110 has a contour that generally conforms to the profile of the reflector 100 for a close fit with a center gap (not shown but similar to gap 54 (FIG. 1A)). The longitudinal sections 101, 102 are each about four feet long, so that the total length of the reflector 100 is about eight feet. The center plate 106 includes a pair of longitudinally-oriented and transversely-spaced slots 114 that are configured to receive the threaded posts 87 of a pair of clips 60 and be fastened by nuts 86 to a pair of spaced-apart parallel T-bars 11.

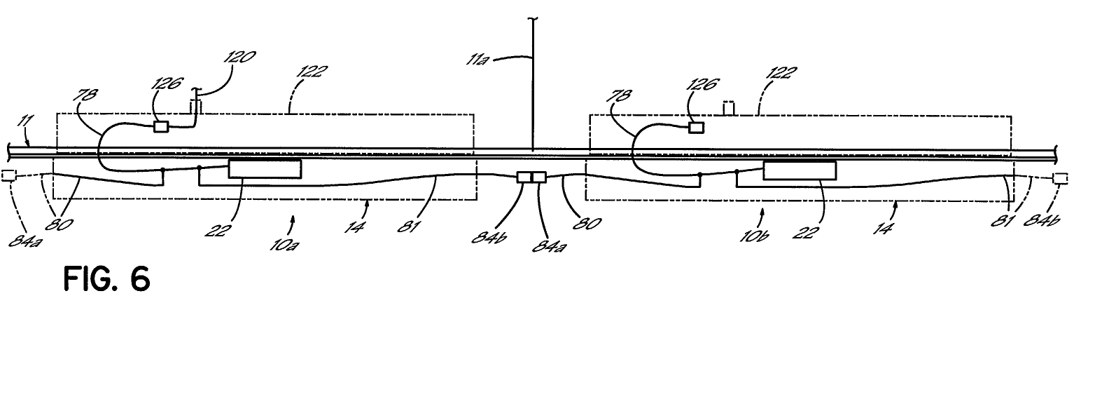

With reference to FIG. 6, in an alternative installation configuration according to the present invention, a plurality of, for example, two luminaires 10a, 10b, each of which is identical to luminaire 10, are mounted in supported functional positions to the T-bars 11 of a suspended ceiling. Longitudinal ends of the luminaires 10a, 10b are arranged in an adjacent, end-to-end fashion to facilitate the sharing of electrical power. To that end, the input power line 78 of luminaire 10a, for example, is connected to an AC power line 120, which energizes the ballast 22 of luminaire 10a. The auxiliary power lines 80 and 81 of luminaire 10a are also energized, when connected to a load, by electrical power provided to the input power line 78. The electrical connector 84a of auxiliary power line 80 is electrically interconnected with the electrical connector 84b of luminaire 10b. As a result, the ballast 22 of luminaire 10b is energized via electrical power transmitted over auxiliary power line 80. In this alternative installation configuration, electrical power is shared or daisy-chained in a parallel circuit between the two luminaires 10a, 10b such that only a single connection is required to a power line, such as the power line 120. The number of luminaires 10 that may share electrical power from power line 120 is limited by the current capacity of the source of electrical power and safety related considerations.

In a representative retrofitting procedure of a lighting system in which the existing lighting fixtures were replaced with a plurality of fluorescent luminaires 10 according to the present invention and having modern ballasts, lamps and reflectors, the lighting output was increased by about 25 percent from about 58 footcandles to about 73 footcandles and the power consumption per luminaire was reduced from about 148 watts to about 102 watts, which represents an energy savings of about 31 percent. For a typical commercial installation and at current power rates, this energy savings would produce a significant cost reduction for operating the lighting system in excess of $30,000 per annum.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. For example, the fluorescent luminaire 10 of the present invention may also be mounted using conventional fasteners directly on a ceiling that is not a suspended ceiling. The invention in its broader aspects is therefore not limited to the specific details, representative apparatus and method and illustrative examples shown and described. Accordingly, departures may be made from such details without departing from the scope or spirit of applicants' general inventive concept.

What is claimed is:

1. A low-profile fluorescent luminaire for housing a fluorescent lamp, comprising:
a spine having a longitudinally-spaced pair of transverse edges and a longitudinal axis extending between the transverse edges;
a pair of end plates, each of said end plates attached to said spine adjacent one of the transverse edges and each of said end plates having a transverse dimension greater than a transverse dimension of said spine, said end plates and said spine positioned on one side of a horizontal plane vertically spaced from the longitudinal axis;
a longitudinally-extending reflector attached to at least one of the end plates, said reflector positioned on the other side of the horizontal plane;
a pair of lamp sockets, one of said lamp sockets mounted to each of said end plates, said lamp sockets having a confronting relationship and longitudinally spaced to support the fluorescent lamp therebetween; and
a ballast adapted to be operably connected between a source of electrical power and said lamp sockets for energizing the fluorescent lamp.

2. The low-profile fluorescent luminaire of claim 1, wherein each end plate further comprises a planar panel and a socket plate, each of said socket plates having a substantially-planar platform positioned a spaced vertical distance from the planar panel, the platforms being substantially coplanar and lying in the horizontal plane.

3. The low-profile fluorescent luminaire of claim 2, wherein each of the platforms has a transverse edge and a notch formed adjacent each transverse edge, each of the notches dimensioned to receive a hanger portion of one of said lamp sockets.

4. The low-profile fluorescent luminaire of claim 3, wherein said reflector has a reflective surface extending longitudinally between opposed transverse edges and a cutout formed in each transverse edge, each cutout dimensioned to receive a hanger portion of one of said lamp sockets such that the hanger portion protrudes through the cutout, and the notch, when registered, and projects above the reflective surface of said reflector.

5. The low-profile fluorescent luminaire of claim 2, wherein a base portion of each lamp socket is captured between each of said socket plates and said end plates.

6. The low-profile fluorescent luminaire of claim 1, wherein each of said end plates comprises a base panel having:
an opposed pair of substantially parallel transverse sides; and
an opposed pair of substantially parallel longitudinal sides, the transverse sides having a greater dimension than the longitudinal sides and the transverse sides substantially perpendicular to the longitudinal axis of said spine, the transverse sides having a transverse dimension greater than a transverse dimension of said spine.

7. The low-profile fluorescent luminaire of claim 1, wherein:
said spine further comprises a substantially-planar support surface adjacent each of the transverse edges; and
each of said end plates further comprises a substantially-rectangular, planar wall mounted transversely to one of the support surfaces, said walls having a transverse dimension greater than a transverse dimension of said spine.

8. The low-profile fluorescent luminaire of claim 1, wherein said spine further comprises:
a longitudinally-extending base wall having a pair of transversely-spaced side edges; and
a stepped flange integral with each of the side edges, the flanges and the base wall defining a longitudinal recessed channel extending along the longitudinal axis of said spine.

9. The low-profile fluorescent luminaire of claim 8, wherein said ballast is affixed to the base wall and is positioned with the recessed channel.

10. The low-profile fluorescent luminaire of claim 8, wherein:
each of the flanges has a substantially-planar support surface; and
each of said end plates has a substantially planar panel which is attached in an abutting contact to the support surface.

11. The low-profile fluorescent luminaire of claim 8, wherein each of said flanges extends longitudinally beneath one of said end plates.

12. The low-profile fluorescent luminaire of claim 1, wherein:
each said end plate comprises a substantially planar base panel and a vertical wall oriented substantially transverse to the longitudinal axis of said spine and projecting vertically from the base panel, the vertical wall having a contoured edge, and
said reflector comprises a reflecting surface having a surface contour that closely conforms to the contoured edge of each vertical wall.

13. The low-profile fluorescent luminaire of claim 12, wherein:
said reflector further comprises a plurality of transversely-planar, longitudinally-extending reflective surfaces having a generally confronting relationship with the fluorescent lamps, the reflective surfaces having interconnected side edges arranged with an angular relationship to create a segmented transverse surface contour; and
the contoured edge of each of the vertical walls has a segmented profile that matches the segmented transverse surface contour of said reflector for a close-fitting engagement therebetween.

14. The low-profile fluorescent luminaire of claim 1, further comprising:
a plurality of fasteners adapted for fastening the end plates to a pair of substantially parallel, spaced-apart T-bars of a suspended ceiling, each of said fasteners having a flange portion for engaging one of the T-bars and a threaded post attached to the flange;
a plurality of nuts for engaging the posts; and
each of said end plates further comprises a pair of longitudinally-extending oval slots having a transverse spacing substantially equal to the spacing between the T-bars, each of the slots dimensioned to receive a threaded post-portion of one of the fasteners, and the slots permitting longitudinal adjustment of the position of the luminaire relative to the fasteners.

15. The low-profile fluorescent luminaire of claim 1, further comprising a center plate mounted transversely near the midpoint of said spine and wherein said reflector further comprises two abutting longitudinally-extending reflector sections, each of the reflector sections attached to said center plate.

16. The low-profile fluorescent luminaire of claim 15, wherein said center plate further comprises a pair of vertically-extending flanges oriented substantially transverse to the longitudinal axis of said spine, each of the flanges having a contoured transverse edge that contacts the surface contour of one of said reflector sections in a conforming contact.

17. The low-profile fluorescent luminaire of claim 1, wherein said ballast further comprises a primary power line and an auxiliary power line having one end electrically connected as a branch of the primary power line, the primary power line for selectively interconnecting said luminaire with a source of electrical power, and another end of the auxiliary power line having an electrical connector selectively operable for one of receiving electrical power from and supplying electrical power to a second of said luminaires in a parallel circuit.

18. A low-profile fluorescent luminaire for housing a pair of fluorescent lamps, comprising:
a spine having a longitudinally-spaced pair of transverse edges, a pair of transversely-spaced, longitudinal edges extending between the transverse edges, and an laterally-extending flange integral with each of said longitudinal edges, each of the flanges having a planar horizontal support surface;
a pair of generally planar end plates, each said end plate attached to the support surfaces and said end plates having a transverse dimension greater than a transverse dimension of said spine;
a socket plate attached to each of said end plates, each of said socket plates having a substantially-planar platform positioned a spaced vertical distance from said end plate, the platforms being substantially coplanar and said spine and said end plates positioned on one side of a horizontal plane containing the platforms;
a longitudinally-extending reflector attached to at least one of the platforms, said reflector positioned on the opposite side of the plane containing the platforms;
a pair of lamp sockets, one of said lamp sockets mounted to each of said end plates, said lamp sockets having a confronting relationship and longitudinally dimensioned to support the fluorescent lamp therebetween; and
a ballast adapted to be operably connected between a source of electrical power and said lamp sockets for energizing the fluorescent lamp.

19. The low-profile fluorescent luminaire of claim 18, further comprising:
a center plate mounted transversely near the midpoint of said spine; and
said reflector further comprising two abutting longitudinally-extending reflector sections, each reflector section having a portion with a transverse surface contour.

20. The low-profile fluorescent luminaire of claim 19, said center plate further comprising a pair of outwardly-extending flanges oriented substantially transverse to the longitudinal axis of said spine, each of the flanges having a contoured transverse edge that contacts the surface contour of one of said reflector sections in a conforming contact.

21. A method of retrofitting a low-profile luminaire to replace an existing lighting fixture, the existing lighting fixture having a ballast powered by an electrical power line from a source of electrical power and mounted to support structure in a suspended ceiling, the method comprising:
providing a low-profile fluorescent luminaire comprising a longitudinally-extending spine, a pair of end plates mounted at opposite ends of the spine, an elongated reflector mounted longitudinally to the end plates, a ballast having an input power line, and a plurality of lamp sockets arranged to hold at least one fluorescent lamp, the spine and the end plates positioned on one side of a horizontal plane parallel to the longitudinal axis of the spine and the reflector mounted on the other side of the horizontal plane;
disconnecting the electrical power supply line from the ballast of the existing lighting fixture;
positioning the low-profile fluorescent luminaire horizontally below the existing lighting fixture and adjacent to the support structure;
securing the first low-profile fluorescent luminaire to the support structure adjacent to, and beneath, the existing lighting fixture; and
electrically connecting the electrical power supply line to the input power line of the ballast of the low-profile fluorescent luminaire.

22. The method of claim 21, wherein the step of securing further comprises attaching the low-profile fluorescent luminaire with suitable fasteners to a spaced-apart pair of substantially parallel T-bars in a suspended ceiling.

23. The method of claim 21, wherein securing step occurs without first removing the ballast from the existing lighting fixture.

24. The method of claim 21, wherein the existing lighting fixture includes a fluorescent lamp and wherein the securing step occurs without first removing the lamp from the existing lighting fixture.

25. The method of claim 21, wherein the existing lighting fixture includes a generally flat rectangular light-modifying structure and wherein the securing step occurs without first removing the light-modifying structure from the existing lighting fixture.

26. The method of claim 21, wherein the existing lighting fixture includes a fluorescent lamp and a generally flat rectangular light-modifying structure and wherein the securing step occurs without first removing the lamp and the light-modifying structure from the existing lighting fixture.

27. The method of claim 26, wherein securing step occurs without first removing the ballast from the existing lighting fixture.

28. The method of claim 21, wherein the ballast of the low-profile fluorescent luminaire includes an auxiliary power line branching from the primary power line and having an electrical connector, the low-profile fluorescent luminaire being a first low-profile fluorescent luminaire, the method further comprising:
providing a second low-profile fluorescent luminaire;
positioning the second low-profile fluorescent luminaire horizontally adjacent to the support structure and adjacent to the first low-profile fluorescent luminaire;
securing the second low-profile fluorescent luminaire to the support structure; and
electrically connecting the auxiliary power line of the second low-profile fluorescent luminaire to the auxiliary power line of the first low-profile fluorescent luminaire such that the second low-profile fluorescent luminaire receives electrical power from the first low-profile fluorescent luminaire.

29. The method of claim 28, wherein the second low-profile fluorescent luminaire is positioned below a second existing lighting fixture and is secured adjacent to, and beneath, the second existing lighting fixture.
